(19) United States
(12) Patent Application Publication
(10) Pub. No.: US 2003/0067914 A1
(43) Pub. Date: Apr. 10, 2003

(54) Apparatus and method of providing network connection of data processing terminals

(76) Inventor: Seog-Hee Kim, Suwon-shi (KR)

Correspondence Address: Robert E. Bushnell, Suite 300, 1522 K Street, N.W., Washington, DC, 20005, US

(21) Appl. No.: 10/245,400

(22) Filed: Sep. 18, 2002

(30) Foreign Application Priority Data
Sep. 28, 2001 (KR) 2001-60835

(51) Int. Cl. H04L 12/56; H04L 12/66

(52) U.S. Cl. 370/389; 370/352; 370/395.5

(57) ABSTRACT

Disclosed is an apparatus connected to a communication line and providing a network connection of data processing terminals. The apparatus includes an ethernet interface for providing a connection with a first data processing terminal, a universal serial bus (USB) interface for providing a connection with a second data processing terminal, a line interface for providing a connection with the communication line, and a control section for judging the interface corresponding to a destination of a packet received from one of the respective interfaces with reference to a destination address of the packet, and transmitting the received packet to at least one of the respective interfaces.

### CLAIM OF PRIORITY

This application makes reference to, incorporates the same herein, and claims all benefits accruing under 35 U.S.C. §119 from my application entitled APPARATUS AND METHOD FOR PROVIDING NETWORK CONNECT FOR USER DATA PROCESSING TERMINAL filed with the Korean Industrial Property Office on Sep. 28, 2001 and there duly assigned Serial No. 2001-60835.

### BACKGROUND OF THE INVENTION

1. Technical Field

The present invention relates to a data communication system, and more particularly to an apparatus and method of providing a network connection of data processing terminals.

2. Related Art

A modem is a modulator and demodulator, and a network connection device. Also, the modem is a data communication device that converts (i.e., modulates) a digital signal from a computer into an analog signal in order to transmit the analog signal through a communication line, and converts (i.e., demodulates) the analog signal received from the communication line into a digital signal which can be understood by the computer.

The modem is also called a data set, and has been hardware which is indispensable in computer communication. The modem is briefly classified into a dedicated line modem for a dedicated line and a dial-up modem for a switching line such as a general telephone. Recently, home networking has been highlighted, and under such a home network environment, two or more personal computers may be installed for a household.

I have found that there is a need for an improved apparatus and method of providing network connection of data processing terminals, in order to facilitate the networking of those terminals.

### SUMMARY OF THE INVENTION

Accordingly, the present invention has been made to solve the above-mentioned problems occurring in the earlier art, and an object of the present invention is to provide an apparatus and method that can perform data communication among user data terminals using a modem and without installing additional equipment such as a hub, a local area network (LAN) card, and other equipment.

It is another object of the present invention to provide an apparatus and method that can perform a data communication between two user personal computers (PCs) using a modem that simultaneously supports an ethernet port and a universal serial bus (USB) port without requiring additional equipment such as a hub, a local area network (LAN) card, and other equipment.

It is still another object of the present invention to provide an apparatus and method that can provide a network connection of a plurality of data processing terminals using a network connection device.

In order to accomplish these objects, there is provided an apparatus connected to a communication line and providing a network connection of data processing terminals, the apparatus comprising an ethernet interface for providing a connection with a first data processing terminal, a universal serial bus (USB) interface for providing a connection with a second data processing terminal, a line interface for providing a connection with the communication line, and a control section for judging the interface corresponding to a destination of a packet received from one of the respective interfaces with reference to a destination address of the packet, and transmitting the received packet to at least one of the respective interfaces.

In another aspect of the present invention, there is provided a method of providing a network connection of first and second data processing terminals using a network connection apparatus including a public network line interface, an ethernet interface, a universal serial bus (USB) interface, a control section for controlling the whole network connection device, and a memory having an address-learning table for registering a source address of a first packet received through the Ethernet interface under the control of the control section, wherein the ethernet interface is connected to the first data processing terminal, and the USB interface is connected to the second data processing terminal, the method comprising a first step of registering the source address of the first packet in the address-learning table if the first packet is received through the ethernet interface, a second step of transmitting the first packet to the USB interface if a destination address of the first packet having the registered source address corresponds to the second data processing terminal, a third step of judging if a destination address of a second packet is registered in the address-learning table if the second packet is received through the USB interface, and a fourth step of transmitting the second packet to the ethernet interface if it is judged that the destination address of the second packet is registered in the address-learning table.

To achieve these and other objects in accordance with the principles of the present invention, as embodied and broadly described, the present invention provides an apparatus connected to a communication line and providing a network connection for data processing terminals, the apparatus comprising: an ethernet interface providing a connection with at least a first data processing terminal; a universal serial bus (USB) interface providing a connection with at least a second data processing terminal; a line interface providing a connection with the communication line; and a control section determining a destination of a packet, the packet being received from at least one interface selected from among said ethernet interface, universal serial bus interface, and line interface, said control section transmitting the received packet to at least one of said interfaces in dependence upon the determined destination.

To achieve these and other objects in accordance with the principles of the present invention, as embodied and broadly described, the present invention provides an apparatus connected to a data communication line and providing a network connection of data processing terminals, the apparatus comprising: an ethernet interface providing a connection with a plurality of first data processing terminals; a universal serial bus (USB) interface providing a connection with at least a second data processing terminal; a line interface providing a connection with the data communication line; and a control section counting a number of source addresses registered in an address-learning table; said control section registering a source address of a received packet in the address-learning table when the counted number of source addresses does not exceed a predefined value and the source address is not already registered in the table; said control section not registering the source address of the received packet in the address-learning table when the counted number of source addresses exceeds the predefined value; the received packet being received from at least one interface selected from among said ethernet interface, universal serial bus interface, and line interface; said control section determining a destination of the received packet and transmitting the received packet to at least one of said interfaces in dependence upon the determined destination, when said control section registers the source address of the received packet.

To achieve these and other objects in accordance with the principles of the present invention, as embodied and broadly described, the present invention provides an apparatus providing a network connection of data processing terminals, the apparatus comprising: a network connection device being connected to a network, and having an ethernet interface and a universal serial bus (USB) interface; a hub connected to said ethernet interface; a plurality of first data processing terminals being connected to said hub; and a second data processing terminal connected to said universal serial bus interface; said network connection device further comprising: a memory having an address-learning table for registering source addresses of received packets; and a control section selectively registering a first source address of a first received packet in the table in accordance with whether the first source address is registered in the table, and in accordance with whether a predetermined number of terminals are registered in the table; said control section transmitting the first packet to the universal serial bus interface when the first packet is received through said ethernet interface and the first packet has a first source address registered in the table and the first packet has a first destination address corresponding to said second data processing terminal; said control section selectively registering a second source address of a second received packet in the table in accordance with whether the second source address is registered in the table, and in accordance with whether the predetermined number of terminals are registered in the table; said control section transmitting the second packet to the ethernet interface when the second packet is received through said universal serial bus interface and the second packet has a registered source address and the second packet has a second destination address corresponding to at least one of said first data processing terminals.

To achieve these and other objects in accordance with the principles of the present invention, as embodied and broadly described, the present invention provides a method, comprising: providing a network connection of at least a first data processing terminal and a second data processing terminal with a network connection device, the network connection device having a public network line interface, an ethernet interface, a universal serial bus (USB) interface, a control section controlling the network connection device, and a memory having an address-learning table registering a first source address of a first packet received through the ethernet interface under the control of the control section, the ethernet interface being connected to the first data processing terminal, the universal serial bus interface being connected to the second data processing terminal; registering the first source address of the first packet in the address-learning table when the first packet is received through the ethernet interface and when a predetermined number of source addresses in the table has not been exceeded; transmitting the first packet to the universal serial bus interface when a first destination address of the first packet having the registered source address corresponds to the second data processing terminal; determining when a second destination address of a second packet is registered in the address-learning table when the second packet is received through the universal serial bus interface; and transmitting the second packet to the ethernet interface when it is determined that the second destination address of the second packet is registered in the address-learning table.

To achieve these and other objects in accordance with the principles of the present invention, as embodied and broadly described, the present invention provides a method, comprising: providing a network connection of a plurality of first data processing terminals and at least a second data processing terminal with a network connection device including a public network line interface, an ethernet interface, a universal serial bus interface, a control section for controlling the network connection device, and a memory having an address-learning table for registering a first source address of a first packet received through the ethernet interface under the control of the control section, the ethernet interface being connected to a hub, the hub being connected to the plurality of the first data processing terminals, and the universal serial bus interface being connected to the second data processing terminal; selectively registering the first source address of the first packet in the address-learning table in accordance with whether the first source address is registered in the address-learning table, and in accordance with whether a predetermined number of the first data processing terminals that can be connected to the ethernet interface through the hub has been exceeded, when the first packet is received through the ethernet interface; transmitting the first packet to the universal serial bus interface when a first destination address of the first packet having the registered source address corresponds to the second data processing terminal; determining whether a second destination address of a second packet is registered in the address-learning table when the second packet is received from the universal serial bus interface; and transmitting the second packet to the ethernet interface when it is determined that the second destination address of the second packet is registered in the address-learning table.

To achieve these and other objects in accordance with the principles of the present invention, as embodied and broadly described, the present invention provides a method, comprising: receiving a first packet; searching and checking whether a first source address of the first received packet is registered in an address-learning table; when the first source address is not registered in the table, determining whether a number of source addresses in the table exceeds a predetermined number; when the first source address is not registered in the table and the predetermined number of addresses in the table is exceeded, discarding the first received packet; when the first source address is not registered in the table and the predetermined number of addresses in the table is not exceeded, registering the first source address in the table; when the first source address of the first received packet is registered in the table, determining the first destination address of the first received packet; when the first destination address corresponds to a broadcast packet, transmitting the first received packet at least to the plurality of ports; and when the first destination address does not correspond to a broadcast packet, transmitting the first received packet to a destination data processing terminal corresponding to the first destination address through a destination port, the destination port being selected from among a plurality of ports including at least a first ethernet port and at least a first universal serial bus port.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a view illustrating a network construction of a cable system;

FIG. 2 is a view illustrating a hardware construction of a cable modem, in accordance with the principles of the present invention;

FIG. 3 is a view illustrating an external appearance of a cable modem having an ethernet port and a universal serial bus (USB) port, in accordance with the principles of the present invention;

FIG. 4 is a view explaining the number of user personal computers that can be connected to an ethernet port and a universal serial bus (USB) port of a cable modem, in accordance with the principles of the present invention;

FIG. 5 is a flowchart illustrating the control process of a central processing unit (CPU) of a cable modem when a packet is received from an ethernet port, in accordance with the principles of the present invention;

FIG. 6 is a flowchart illustrating the control process of a central processing unit (CPU) of a cable modem when a packet is received from a universal serial bus (USB) port, in accordance with the principles of the present invention;

FIG. 7 is a view illustrating a packet flow in a cable modem, in accordance with the principles of the present invention; and

FIG. 8 is a view illustrating a packet data structure, in accordance with the principles of the present invention.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific s decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

In order to support the networking among the personal computers, a user should additionally purchase a hub, a local area network (LAN) card, and possibly other hardware and software. This is because one personal computer is connected to one modem. In order to perform a data communication among two or more personal computers using one modem, a separate switching hub and a local area network (LAN) card for the LAN communication should be purchased and installed. After all, a modem is connected to a hub, two or more personal computers are connected to the hub, and a LAN card for local area communication among the personal computers should be installed for each of the respective personal computers.

Meanwhile, the interface between a recent armored high-speed modem terminal (for example, x-digital subscriber line (xDSL) modem, cable modem, etc.) and the personal computer has been changed from a type that supports only an initial ethernet interface to a type that supports even a universal serial bus (USB) interface enabling a hot plug-in. Accordingly, if it is possible to perform a data communication between two user personal computers using a modem that supports a general ethernet interface and USB interface without additional installation of a hub and a separate local area network (LAN) card, it will provide a great convenience and economic advantages to the users.

In the embodiment of the present invention, in order to enable data communication between two user personal computers by means of a modem which is a generally used network connection device without installing an additional hub and separate local area network (LAN) card, a modem capable of simultaneously supporting an ethernet port and a universal serial bus (USB) port is employed. The modem according to the present invention is an example of a network connection device. In general, a modem supports the ethernet port. Recently, a modem capable of supporting the universal serial bus (USB) port also, which is a new data interface, is employed.

The modem that simultaneously supports the ethernet port and the universal serial bus (USB) port may be a cable modem or an asymmetrical digital subscriber line (ADSL) modem. In the embodiment of the present invention, the cable modem is taken as an example of the network connection device that simultaneously supports the ethernet port and the USB port. However, it should be understood that the scope of the present invention is not limited to the cable modem only, but the present invention can be applied to any network connection device that simultaneously supports the ethernet port and the USB port such as the cable modem, ADSL modem, etc. The cable modem is a device that provides extremely high-speed Internet communication to a user using a hybrid fiber coax cable (HFC) network. Since the extremely high-speed Internet service using the cable modem is a service that uses the existing cable TV network, it is profitable to a subscriber of a cable TV. In case of using the cable modem, the high speed of the optical cable is applied to the Internet, and thus prompt service can be provided.

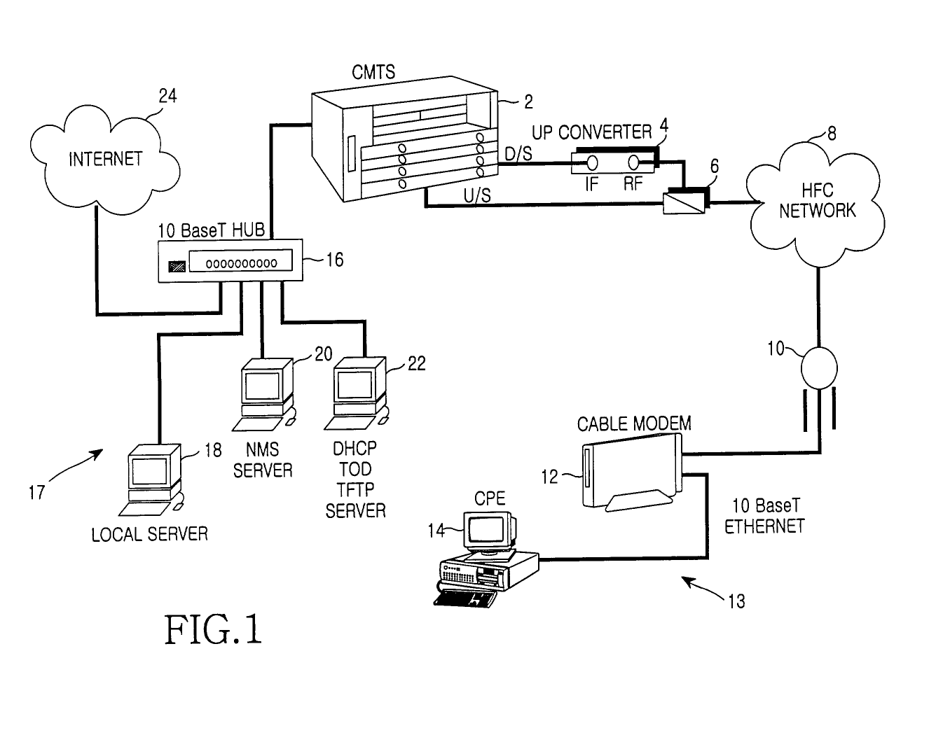

FIG. 1 is a view illustrating a network construction of a cable system using a cable modem. Referring to FIG. 1, the cable system can briefly be divided into three parts: a cable modem termination system (CMTS) 2 that is also called a headend, a subscriber household device 13, and an Internet central device 17. The cable modem termination system (CMTS) 2 controls all cable modems including a cable modem 12, converts digital data into a radio frequency (RF) signal, and provides the RF signal to a corresponding cable modem 12 through a hybrid fiber coax cable (HFC) network 8. The subscriber household device 13 includes the cable modem 12 connected to a hybrid fiber coax cable (HFC) cable network 8 through a splitter 10, and a customer premises equipment (CPE) 14 connected to the cable modem 12.

The Internet central device 17 includes various kinds of servers 18, 20, and 22. The server 18 is a local server that manages local information. The server 20 is a network management system (NMS) server that mounts a network management system (NMS) program for controlling the cable system. The server 22 is a server of dynamic host control protocol (DHCP), trivial file transmission protocol (TFTP), and time of delay (TOD). The server 22 is a server that mounts a DHCP program for allocating an Internet protocol (IP) to the cable modem 12, a trivial file transmission protocol (TFTP) program for transmitting a configuration file required by the cable modem 12, and a time of delay (TOD) program for setting the present time in the cable modem 12. The respective servers 18, 20, and 22 are connected to a 10BaseT hub 16. This 10BaseT hub 16 is a device that plays a central role of a star topology network, and connects a cable modem termination system (CMTS) 2, Internet 24, and various kinds of servers 18, 20, and 22.

The signal outputted from the cable modem termination system (CMTS) 2 in order to be transmitted to the cable modem of the subscriber household device 13 is the intermediate frequency (IF) signal. This intermediate frequency (IF) signal is applied to an up converter 4, and converted into the radio frequency (RF) signal by the up converter 4. For instance, the up converter 4 converts the intermediate frequency (IF) signal of 44 megahertz (MHz) outputted from the cable modem termination system (CMTS) 2 into the RF frequency signal of 453 MHz or 99 MHz. The radio frequency (RF) signal converted by the up converter 4 is transmitted to the hybrid fiber coax cable (HFC) cable network 8 through a di-plex filter 6.

The frequency used in the cable system is briefly divided into a downstream (D/S) frequency and an upstream (U/S) frequency. The downstream (D/S) frequency is a frequency of 88˜860 megahertz (MHz) transmitted to the cable modem 12 by the cable modem termination system (CMTS) 2. The upstream (U/S) frequency is a frequency of 5˜42 MHz used when the cable modem 12 sends data to the cable modem termination system (CMTS) 2. These two frequencies are combined (i.e., downstream) or separated (i.e., upstream) by the di-plex filter 6. The di-plex filter 6 combines the downstream frequency and the upstream frequency in the downstream direction, from cable modem termination system (CMTS) 2 toward cable modem 12. The di-plex filter 6 separates the downstream frequency and the upstream frequency in the upstream direction from cable modem 12 toward cable modem termination system (CMTS) 2. The data transmitted through the hybrid fiber coax cable (HFC) cable network 8 is split through a splitter 10, and the split data are transmitted to the respective cable modem 12 of the subscribers.

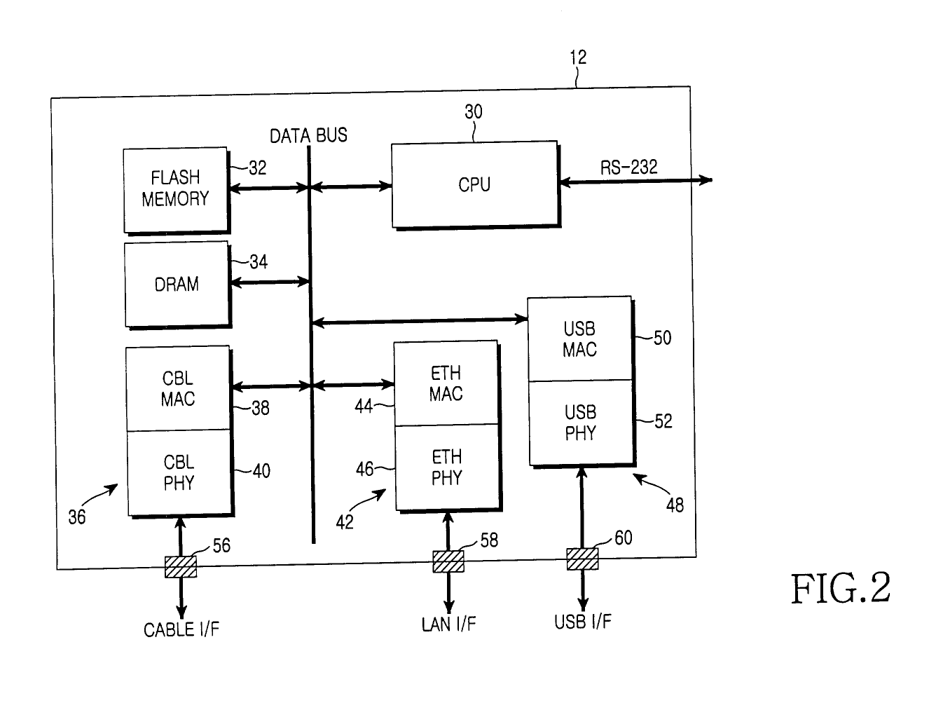

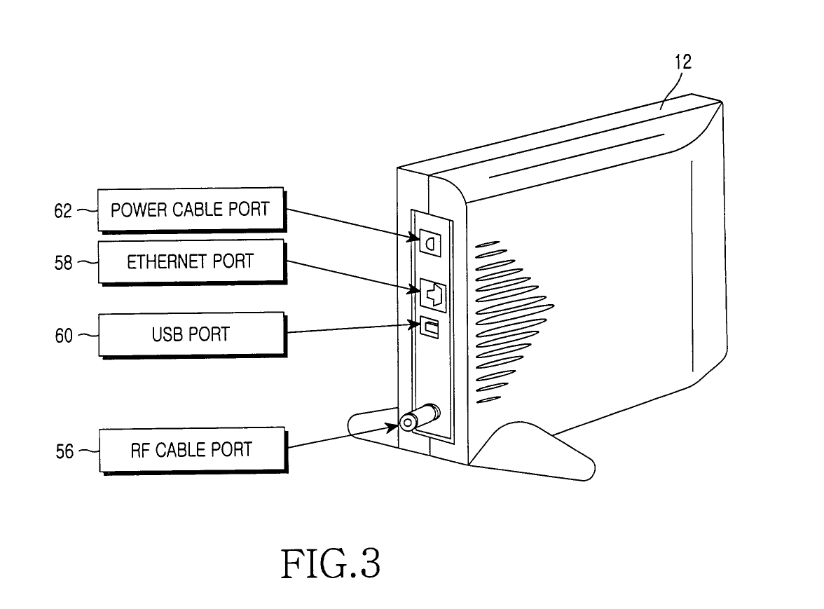

FIG. 2 is a view illustrating the hardware construction of the cable modem according to an embodiment of the present invention. The cable modem 12 includes a construction that simultaneously supports the ethernet port and the universal serial bus (USB) port. FIG. 3 is a view illustrating the external appearance of the cable modem that simultaneously supports the ethernet port and the universal serial bus (USB) port.

Referring to FIG. 2, a central processing unit (CPU) 30 controls the whole cable modem. A flash memory 32 stores therein a real-time operating system (OS) program performed by the CPU 30. A dynamic random access memory (DRAM) 32 is a typical memory that stores therein various kinds of data under the control of the CPU 30. The flash memory 32 is a memory in which the data stored therein is not deleted even if the power is off, and stores therein the real-time operating system (OS) program. If the power is on, the real-time operating system (OS) program is copied into the dynamic random access memory (DRAM) 34, and then executed to boot the cable modem.

The downstream signal outputted from the cable modem termination system (CMTS) 2 is provided in the form of a radio frequency (RF) signal to the cable modem 12 through the hybrid fiber coax cable (HFC) network 8 and the splitter 10. The downstream signal is applied to a cable modem physical layer (CBL PHY) 40 of a radio frequency (RF) part 36 through an RF cable port 56 of the cable modem 12, and then demodulated into digital data by a cable modem media access control (CBL MAC) section 38. Thereafter, the demodulated digital data is transferred to the central processing unit (CPU) 30 through an internal data bus, and the packet data are transmitted to the destination address through the ethernet port 58 or the universal serial bus (USB) port 60. The FIG. 2 also shows the following three interfaces: a cable interface (I/F) adjacent to the radio frequency (RF) cable port 56; a local area network (LAN) interface (I/F) adjacent to the ethernet port 58; and a universal serial bus interface (I/F) adjacent to the USB port 60. The local area network interface can also be referred to as an ethernet interface. The cable interface can also be referred to as a line interface.

The cable modem 12 of FIG. 2 is provided with the ethernet port 58, the USB port 60, an ethernet part 42 for supporting the ethernet port 58, and a USB part 48 for supporting the USB port 60. The ethernet part 42 includes an ethernet physical layer (ETH PHY) 46 and an ethernet media access control (ETH MAC) section 44. The USB part 48 includes a USB physical layer (USB PHY) 50 and a USB media access control (USB MAC) section 48.

FIG. 3 shows the external appearance of the radio frequency (RF) cable port 56, the ethernet port 58, and the universal serial bus (USB) port 60 illustrated in FIG. 2, and also shows the external appearance of a power cable port 62 not illustrated in FIG. 2.

In the embodiment of the present invention, the data communication between two or more user personal computers (PCs) connected to the cable modem 12 can be performed using the ethernet port 58 and the universal serial bus (USB) port 60 of the cable modem 12 without other equipment (i.e., without an additional hub and without a local area network card). For this, in the embodiment of the present invention, a packet-switching function is 10 implemented between the ethernet port 58 and the USB port 60 of the cable modem 12. Typically, the user connects a desktop personal computer (PC) to the ethernet port 58, and connects a notebook personal computer (PC) to the USB port 60 that supports the hot plug-in. This is because the local area network (LAN) cable connected to the Ethernet port 58 enables the communication at a distance of 100 meters at maximum, but the universal serial bus (USB) cable connected to the universal serial bus (USB) port enables the communication only at a distance of 5 meters at maximum. It will be no hindrance within the limited distance to connect both the notebook computer and the desktop computer to the ethernet port 58 by using hub 70.

If the packet switching function is implemented between the ethernet port 58 and the universal serial bus (USB) port 60 of the cable modem 12 according to the embodiment of the present invention, data can be easily shared between the desktop computer and the notebook computer. There is not need to install an expensive Personal Computer Memory Card International Association (PCMCIA) local area network (LAN) card into the notebook computer.

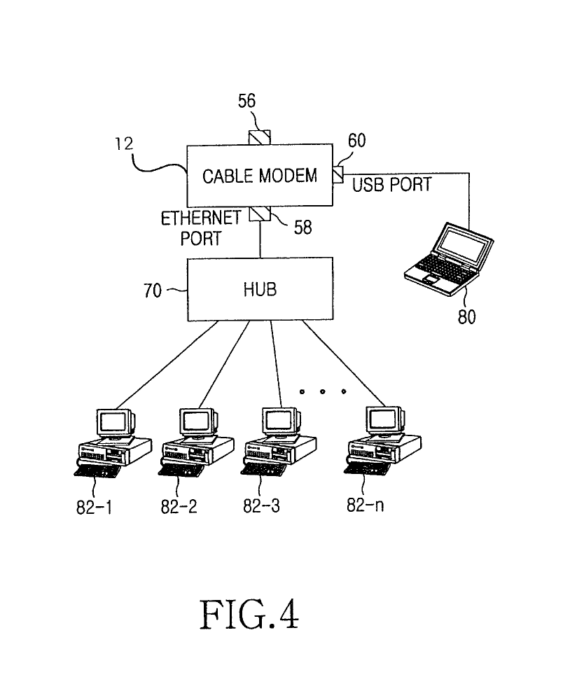

FIG. 4 is a view explaining the number of user computers that can be connected to the ethernet port and the universal serial bus (USB) port of the cable modem 12 according to the embodiment of the present invention. One computer 80 is shown connected to USB port 60 in FIG. 4. A plurality of computers 82-1 to 82-n are shown connected to a hub 70 which is connected to the ethernet port 58 in FIG. 4. It is preferable to limit the number of computers connected to the ethernet port 58 in order to have an improved quality of service.

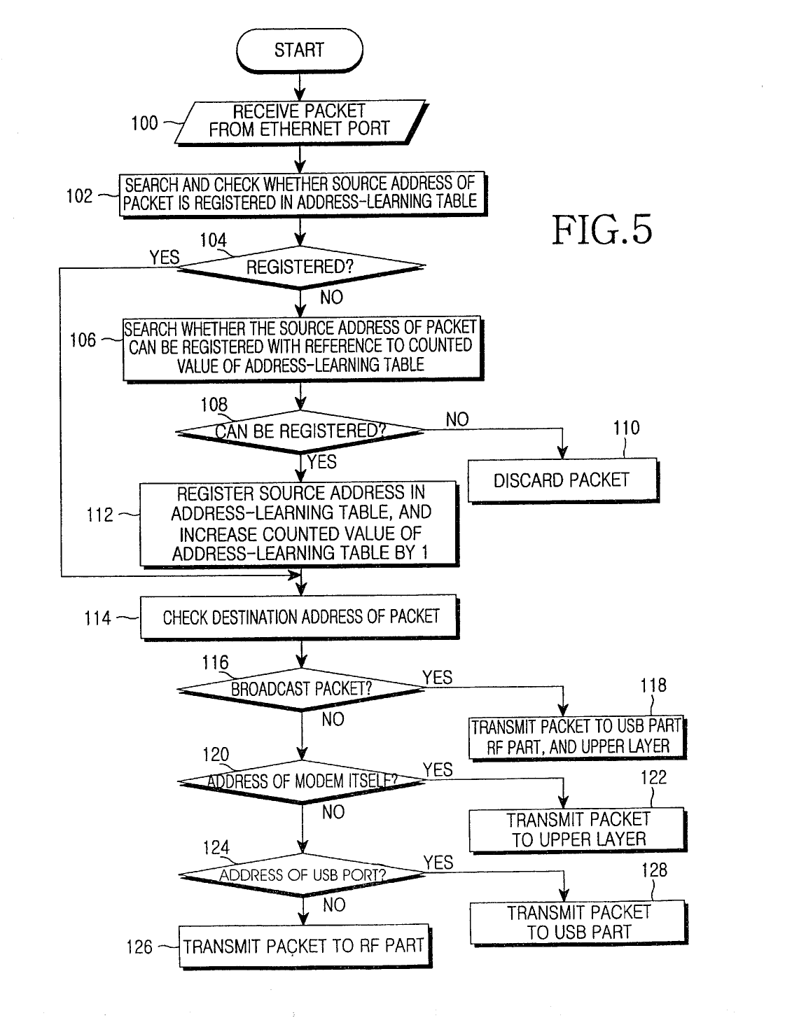

In the embodiment of the present invention, an address-learning table is used as a method of limiting the number of computers connected to the ethernet port 58. The address-learning table is stored in the dynamic random access memory (DRAM) 34 of the cable modem 12. The method of limiting the number of computers connected to the ethernet port 58 of modem 12 by using the address-learning table is described in steps 100 to 112 of FIG. 5.

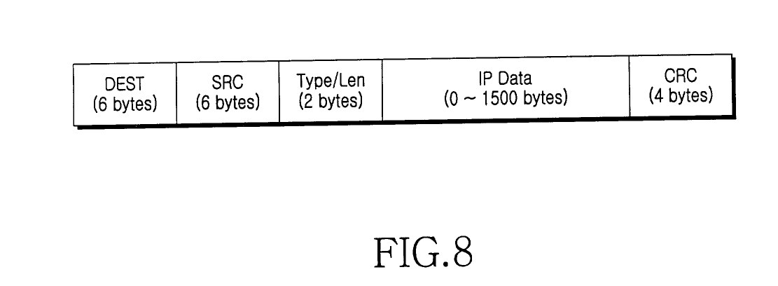

Before explaining the method of limiting the number of computers connected to the ethernet port 58 by using the address-learning table, the construction of a packet data format in the cable modem 12 will be explained with reference to FIG. 8 illustrating the packet data format structure. The packet data format is composed of a destination address (DEST), a source address (SRC), type and length information (Type/Len), Internet protocol data (IP Data), and cyclic redundancy check (CRC) information.

Referring now to FIG. 5, if a packet having a format of FIG. 8 is received into modem 12 from the ethernet port 58 (step 100 of FIG. 5), the central processing unit (CPU) 30 of modem 12 proceeds to step 102 of FIG. 5, and checks whether the source address (SRC) is registered in the address-learning table stored in the dynamic random access memory (DRAM) 34 by searching the source address (SRC) of the packets.

Thereafter, the central processing unit (CPU) 30 judges if the source address (SRC) is registered at step 104 of FIG. 5. If it is judged that the source address (SRC) of the received packet has already been registered in the address-learning table, the CPU 30 directly proceeds to step 114 of FIG. 5. On the contrary, if it is judged that the source address (SRC) of the received packet has not been registered in the address-learning table at step 104, the CPU 30 of modem 12 proceeds to step 106 of FIG. 5.

At step 106 of FIG. 5, the central processing unit (CPU) 30 searches whether the source address registration is possible with reference to the present counted value of the address leaning table for counting the number of personal computers registered in the source address. If the present counted value of the address-learning table does not exceed the predetermined maximum number of personal computers, the CPU 30 judges that the source address registration is possible, while if the present counted value of the address-learning table exceeds the predetermined maximum number of personal computers, the CPU 30 judges that the source address registration is impossible.

At step 108 of FIG. 5, the central processing unit (CPU) 30 judges whether the source address registration is possible in the same manner as above, and if possible, the CPU 30 proceeds to step 112 of FIG. 5, and registers the source address of the received packet in the address-learning table.

Also, at step 112, the central processing unit (CPU) 30 increases the counted value of the address-learning table by “1”. On the contrary, if the source address registration is impossible as a result of the judgment at step 108 of FIG. 5, the CPU 30 of modem 12 discards the received packet at step 110 of FIG. 5.

In the embodiment of the present invention, the number of personal computers connected to the ethernet port 58 is limited as described above. With respect to a packet that has already been registered or is to be registered in the address-learning table, it is transmitted to the outside of the cable modem 12 through the radio frequency (RF) cable port 56 or the universal serial bus (USB) port 60, and thus the data service becomes possible.

In Table 1 below, it is exemplified that the data service is performed with respect to 4 personal computers at maximum through the address-learning table. In Table 1, “0” is indicated five times as an “Enable” item, and the first one (corresponding to No. 1 in 5 Table 1) is for writing the address of the cable modem 12.

TABLE 1

| No. | Enable | MAC Address |
|---|---|---|
| 1 | O | 0x0000F0302504 |
| 2 | O | 0x00D0B709525B |
| 3 | O | 0x0000F0302505 |
| 4 | O | |
| 5 | O | |
| 6 | X | |
| 7 | X | |
| 8 | X | |
| 9 | X | |
| 10 | X | |
| 11 | X | |
| 12 | X | |
| 13 | X | |
| 14 | X | |
| 15 | X | |
| 16 | X | |

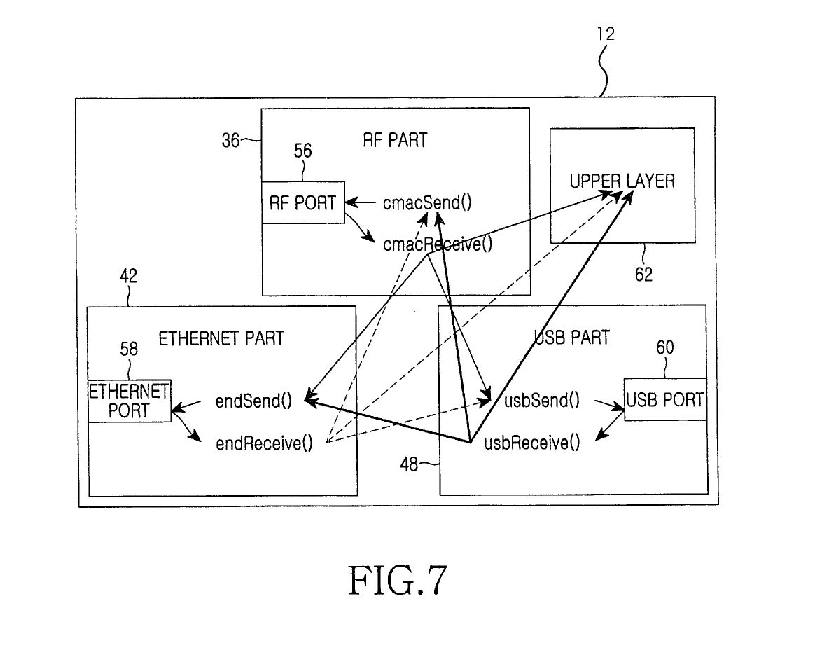

After performing step 112 of FIG. 5, the central processing unit (CPU) 30 checks the destination address (DEST) of the packet received through the ethernet port 58 at step 114 of FIG. 5. Thereafter, at step 116 of FIG. 5, the CPU judges whether the received packet is a broadcast packet. For example, if the destination address (DEST) of the received packet is “0xff ffff ffff”, it means that the received packet is the broadcast packet. If the received packet is the broadcast packet, the CPU 30 proceeds to step 118, and transmits the packet to the universal serial bus (USB) part 48, the radio frequency (RF) part 36, and an upper layer 62 (FIG. 7 inside the cable modem 12, respectively.

If the received packet is not the broadcast packet as a result of judgment at step 116 of FIG. 5, the central processing unit (CPU) 30 proceeds to step 120 of FIG. 5, and judges whether the destination address (DEST) of the received packet is the address of the cable modem itself. If it is judged that the destination address is the address of the cable modem 12, the CPU 30 transmits the packet to the upper layer 62 inside the cable modem 12 illustrated in FIG. 7.

Meanwhile, if it is judged that the destination address is not the address of the cable modem 12 itself, as a result of judgment at step 120 of FIG. 5, the central processing unit (CPU) 30 proceeds to step 124 of FIG. 5, and judges whether the destination address (DEST) of the received packet is the address of the user personal computer connected to the universal serial bus (USB) port 60. If it is judged that the destination address (DEST) is not the address of the user personal computer connected to the USB port 60 at step 124, the CPU 30 recognizes the received packet as the packet to be transmitted to the radio frequency (RF) part 36, and proceeds to step 126 of FIG. 5 to transmit the packet to the RF part 36. If it is judged that the destination address (DEST) of the received packet is the address of the user personal computer connected to the USB port 60 at step 124, the CPU 30 transmits the packet to the USB part 48.

By performing the method as illustrated in FIG. 5, the central processing unit (CPU) 30 can transmit the packet received through the ethernet port 58 to the universal serial bus (USB) port 60, and thus the data communication between one among the user personal computers 82-1 to 82-N connected to the ethernet port 58 and the user personal computer 80 connected to the USB port 60 can be performed without addition of the hub and the local area network (LAN) card. Thus, the notebook computer 80 can communicate with the computer 82-2 and the notebook computer 80 does not need to have a local area network (LAN) card. Also, no modifications need to be made to hub 70. That is, the notebook computer 80 does not need to be connected to, or added to, the hub 70 or any other hub. The USB port 60 is connected to a USB connector of the notebook computer 80 with a USB cable.

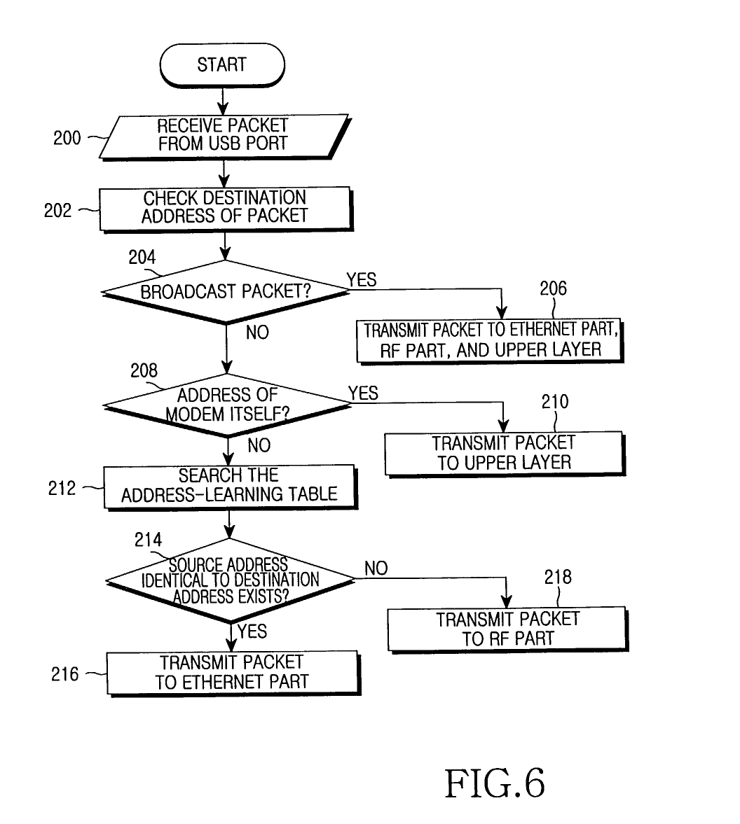

FIG. 6 shows the packet switching operation of the central processing unit (CPU) 30 of modem 12 when the packet having the format of FIG. 8 is received into the modem 12 from the universal serial bus (USB) port 60.

If the packet having the format of FIG. 8 is received into modem 12 from the universal serial bus (USB) port 60 to the central processing unit (CPU) 30 (step 200 of FIG. 6), the CPU 30 proceeds to step 202 of FIG. 6, and checks the destination address (DEST) of the packet received through the USB port 60. Thereafter, at step 204 of FIG. 6, the CPU 30 judges whether the received packet is a broadcast packet. For example, if the destination address (DEST) of the received packet is “0xff ffff ffff”, it means that the received packet is the broadcast packet. If the received packet is the broadcast packet, the CPU 30 proceeds to step 206, and transmits the packet to the ethernet part 42, the radio frequency (RF) part 36, and an upper layer 62 inside the cable modem 12, respectively.

If the received packet is not the broadcast packet as a result of judgment at step 204 of FIG. 6, the central processing unit (CPU) 30 proceeds to step 208 of FIG. 6, and judges whether the destination address (DEST) of the received packet is the address of the cable modem itself. If it is judged that the destination address is the address of the cable modem 12, the CPU 30 transmits the packet to the upper layer 62 inside the cable modem 12 illustrated in FIG. 7.

Meanwhile, if it is judged that the destination address is not the address of the cable modem 12 itself as a result of judgment at step 208 of FIG. 6, the central processing unit (CPU) 30 proceeds to step 212, and searches the address-learning table stored in the dynamic random access memory (DRAM) 34. Thereafter, at step 214 of FIG. 6, the CPU 30 judges if the same source address as the destination address of the received packet exists. If it is judged that the same source address as the destination address of the received packet exists, the CPU 30 transmits the packet to the ethernet part 42. If it is judged that the same source address as the destination address of the received packet does not exist at step 214, the CPU 30 recognizes the received packet as the packet to be transmitted to the radio frequency (RF) part 36, and proceeds to step 218 of FIG. 6 to transmit the packet to the RF part 36.

By performing the method as illustrated in FIG. 6, the central processing unit (CPU) 30 can transmit the packet received through the USB port 60 to the ethernet port 58, and thus the data communication between one among the user personal computers 82-1 to 82-n connected to the ethernet port 58 and the user personal computer 80 connected to the universal serial bus (USB) port 60 can be performed without addition of the hub and the local area network (LAN) card. The central processing unit (CPU) 30 can also be referred to as a control section of the modem 12.

FIG. 7 is a view illustrating the packet flow in the cable modem 12. The packet path is determined through the central processing unit (CPU) 30. In FIG. 7, cmacsend( ) and cmacReceive( ), endSend( ) and endReceive( ), and usbSend( ) and usereceive( ) are functions of processing the packets. When the packets are inputted to or outputted from the respective parts 36, 42, and 48, they are called to the CPU 30. The packet applied to the radio frequency (RF) part 36 is received using the cmacReceive( ) function, and the CPU 30 grasps the destination address (DEST) of the packet. If the destination address (DEST) is the universal serial bus (USB)-related address, the CPU 30 calls the usbsendo function of the universal serial bus (USB) part 48, and makes the packet go to the user personal computer 80 connected to the USB port 60. The ethernet part 42 operates in the same manner as the above-described processing of the packet applied to the radio frequency (RF) part 36. If the destination address (DEST) of a packet applied to the RF part 36, the ethernet part 42, or the USB part 48 corresponds to the cable modem 12 itself, the packet is sent up to the upper layer 62, so that the packet is processed through the upper layer 62.

In accordance with the principles of the present invention, a universal serial bus (USB) hub can be easily connected to USB port 60 to allow more than one computer to access modem 12 through USB port 60. For example, a four-port USB hub can be connected to USB port 60 of modem 12, and four notebook computers can be simultaneously connected to the USB hub (via their respective USB connectors). When a packet is received by the modem 12 that has a destination address corresponding to one of the four aforementioned notebook computers connected to the universal serial bus (USB) hub, then the packet will be directed to the USB port 60, to the USB hub, and then to the correct notebook computer connected to the USB hub. In view of this example, steps 124 and 128 of FIG. 5 would be part of the steps used to direct the packet toward the correct notebook computer.

As described above, according to the present invention, the packet switching function is implemented between the ethernet port of the cable modem and the universal serial bus (USB) port of the cable modem, and thus the data communication between two or more user personal computers connected to the cable modem (i.e., network connection device) can be performed without other equipment (i.e., without additional hub and additional local area network card).

In the embodiment of the present invention, the cable modem has been explained as an example of the modem that simultaneously supports the ethernet port and the universal serial bus (USB) port, but the present invention can be applied to any other network connection device that simultaneously supports the ethernet port and the universal serial bus (USB) port such as the cable modem, ADSL modem, and other network devices.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An apparatus connected to a communication line and providing a network connection for data processing terminals, the apparatus comprising:
an ethernet interface providing a connection with at least a first data processing terminal;
a universal serial bus (USB) interface providing a connection with at least a second data processing terminal;
a line interface providing a connection with the communication line; and
a control section determining a destination of a packet, the packet being received from at least one interface selected from among said ethernet interface, universal serial bus interface, and line interface, said control section transmitting the received packet to at least one of said interfaces in dependence upon the determined destination.

2. The apparatus of claim 1, said ethernet interface accommodating a plurality of data processing terminals in addition to said first data processing terminal.

3. The apparatus of claim 2, said universal serial bus interface accommodating a plurality of data processing terminals in addition to said second data processing terminal.

4. The apparatus of claim 1, said control section transmitting the received packet to said ethernet interface, universal serial bus interface, and line interface when the received packet corresponds to a broadcast packet.

5. An apparatus connected to a data communication line and providing a network connection of data processing terminals, the apparatus comprising:
an ethernet interface providing a connection with a plurality of first data processing terminals;
a universal serial bus (USB) interface providing a connection with at least a second data processing terminal;
a line interface providing a connection with the data communication line; and
a control section counting a number of source addresses registered in an address-learning table;
said control section registering a source address of a received packet in the address-learning table when the counted number of source addresses does not exceed a predefined value and the source address is not already registered in the table;
said control section not registering the source address of the received packet in the address-learning table when the counted number of source addresses exceeds the predefined value;
the received packet being received from at least one interface selected from among said ethernet interface, universal serial bus interface, and line interface;
said control section determining a destination of the received packet and transmitting the received packet to at least one of said interfaces in dependence upon the determined destination, when said control section registers the source address of the received packet.

6. The apparatus of claim 5, said control section determining a destination of the received packet and transmitting the received packet to at least one of said interfaces in dependence upon the determined destination, when the source address of the received packet is already registered in the table.

7. The apparatus of claim 6, said control section discarding the received packet when the source address of the received packet is not already registered in the table and the counted number of source addresses exceeds the predefined value.

8. The apparatus of claim 7, said control section transmitting the received packet to said ethernet interface, universal serial bus interface, and line interface when the received packet corresponds to a broadcast packet.

9. The apparatus of claim 5, said control section discarding the received packet when the source address of the received packet is not already registered in the table and the counted number of source addresses exceeds the predefined value.

10. An apparatus providing a network connection of data processing terminals, the apparatus comprising:
a network connection device being connected to a network, and having an ethernet interface and a universal serial bus (USB) interface;
a hub connected to said ethernet interface;
a plurality of first data processing terminals being connected to said hub; and
a second data processing terminal connected to said universal serial bus interface;
said network connection device further comprising:
a memory having an address-learning table for registering source addresses of received packets; and
a control section selectively registering a first source address of a first received packet in the table in accordance with whether the first source address is registered in the table, and in accordance with whether a predetermined number of terminals are registered in the table;
said control section transmitting the first packet to the universal serial bus interface when the first packet is received through said ethernet interface and the first packet has a first source address registered in the table and the first packet has a first destination address corresponding to said second data processing terminal;
said control section selectively registering a second source address of a second received packet in the table in accordance with whether the second source address is registered in the table, and in accordance with whether the predetermined number of terminals are registered in the table;
said control section transmitting the second packet to the ethernet interface when the second packet is received through said universal serial bus interface and the second packet has a registered source address and the second packet has a second destination address corresponding to at least one of said first data processing terminals.

11. A method, comprising:
providing a network connection of at least a first data processing terminal and a second data processing terminal with a network connection device, the network connection device having a public network line interface, an ethernet interface, a universal serial bus s (USB) interface, a control section controlling the network connection device, and a memory having an address-learning table registering a first source address of a first packet received through the ethernet interface under the control of the control section, the ethernet interface being connected to the first data processing terminal, the universal serial bus interface being connected to the second data processing terminal;
registering the first source address of the first packet in the address-learning table when the first packet is received through the ethernet interface and when a predetermined number of source addresses in the table has not been exceeded;
transmitting the first packet to the universal serial bus interface when a first destination address of the first packet having the registered source address corresponds to the second data processing terminal;
determining when a second destination address of a second packet is registered in the address-learning table when the second packet is received through the universal serial bus interface; and
transmitting the second packet to the ethernet interface when it is determined that the second destination address of the second packet is registered in the address-learning table.

12. A method, comprising:
providing a network connection of a plurality of first data processing terminals and at least a second data processing terminal with a network connection device including a public network line interface, an ethernet interface, a universal serial bus interface, a control section for controlling the network connection device, and a memory having an address-learning table for registering a first source address of a first packet received through the ethernet interface under the control of the control section, the ethernet interface being connected to a hub, the hub being connected to the plurality of the first data processing terminals, and the universal serial bus interface being connected to the second data processing terminal;
selectively registering the first source address of the first packet in the address-learning table in accordance with whether the first source address is registered in the address-learning table, and in accordance with whether a predetermined number of the first data processing terminals that can be connected to the ethernet interface through the hub has been exceeded, when the first packet is received through the ethernet interface;
transmitting the first packet to the universal serial bus interface when a first destination address of the first packet having the registered source address corresponds to the second data processing terminal;
determining whether a second destination address of a second packet is registered in the address-learning table when the second packet is received from the universal serial bus interface; and
transmitting the second packet to the ethernet interface when it is determined that the second destination address of the second packet is registered in the address-learning table.

13. A method, comprising:
receiving a first packet at a network device;
searching and checking whether a first source address of the first received packet is registered in an address-learning table;
when the first source address is not registered in the table, determining whether a number of source addresses in the table exceeds a predetermined number;
when the first source address is not registered in the table and the predetermined number of addresses in the table is exceeded, discarding the first received packet;
when the first source address is not registered in the table and the predetermined number of addresses in the table is not exceeded, registering the first source address in the table;
when the first source address of the first received packet is registered in the table, determining the first destination address of the first received packet;
when the first destination address corresponds to a broadcast packet, transmitting the first received packet from the device to a plurality of ports including at least one ethernet port and at least one universal serial but port; and
when the first destination address does not correspond to a broadcast packet, transmitting the first received packet from the device through a destination port to a destination data processing terminal corresponding to the first destination address, the destination port being selected from among the plurality of ports.

14. The method of claim 13, the first source address of the first received packet corresponding to a first data processing terminal connected to said one ethernet port, the first destination address of the first received packet corresponding to the destination data processing terminal connected to said one universal serial bus port.

15. The method of claim 13, the first source address of the first received packet corresponding to a first data processing terminal connected to said one universal serial bus port, the first destination address of the first received packet corresponding to the destination data processing terminal connected to said one ethernet port.

16. The method of claim 15, the table being stored in a dynamic random access memory of the network device.

17. The method of claim 16, the network device being selected from among a cable modem and an asymmetrical digital subscriber line modem.

18. The method of claim 17, the network device having the plurality of ports.

19. The method of claim 16, the network device having the plurality of ports.
